(19) United States
(12) Patent Application Publication
(10) Pub. No.: US 2005/0038914 A1
(43) Pub. Date: Feb. 17, 2005

(54) Method of optimising content presented to a user within a communication network

(76) Inventors: Andrew Prendergast, South Yarra (AU); David Whittle, Sydney (AU); Paul Gerard Cross, Melbourne (AU)

Correspondence Address: Brown Raysman Millstein;Felder & Steiner, 900 Third Avenue, New York, NY, 10022, US

(21) Appl. No.: 10/477,979

(22) PCT Filed: May 16, 2002
(86) PCT No.: PCT/AU02/00600

(30) Foreign Application Priority Data
May 17, 2001 (AU) PR 5056

(51) Int. Cl. G06F 15/16

(52) U.S. Cl. 709/250; 709/220

(57) ABSTRACT

A method of optimising content presented to a user within a communications network, wherein the user (32) establishes a session (6) with the communications network (31) and generates one or more session events (7-19) during that session, the method including the step of: at least once during that session comparing (70-82) the past performance as a traffic stream of multiple sources of content that could be presented to a user to predetermine traffic performance criteria, to enable content (39) to be presented to the user from a content source meeting the predetermined traffic performance criteria.

The present invention relates generally to methods of serving advertising and other content to users within a communications network, and in particular to methods and systems for optimising the presentation of this content. The present invention is suitable for use in the serving of banner advertisements and like content to users browsing the Internet, and it will be convenient to describe the invention in relation to that exemplary application. It will be appreciated, however, that the invention is not limited to use in that application only.

The Internet is becoming an increasingly used means for communication and for conducting commercial transactions. A wide variety of enterprises maintain websites consisting of one or more content sources such as HyperText Markup Language (HTML) documents, or other text, video or audio content. These organisations, known as online publishers, often allocate portions of the content made accessible to users to advertising messages. Unlike traditional media, online publishers are able to rotate advertising messages into and out of a single advertising space each time content is viewed. Currently available advertisement serving technology facilitates this rotation. Every time a user requests an HTML document containing an advertising space, an advertisement server selects an appropriate advertisement and fills the advertising space.

Some advertising serving technology enable the tailoring of advertising content to individual users according to complex targeting algorithms. The raw materials for the targeting of advertising content to individual users are psychographic and demographic databases. Individual psychographic and demographic profiling databases are build based upon users past browsing habits. As users travel from network site to network site, a psychographic profile is built based upon the sites visited, the content retrieved at each site and the advertising messages that have been responded to. Demographic profiling databases are normally built upon personal data volunteered by the user.

Considerable privacy concerns surround the existence of psychographic and demographic profiling databases. Many of the online profiling databases are maintained by a variety of advertising organisations without the knowledge or approval of network users.

There currently exists a need to optimise advertising material presented to user without the need for the profiling of individual users by the establishment of psychographic or demographic databases. The need also exists for a method of optimising advertising and other content delivered to users that is simple and efficient. There also exists a need to provide a method of optimising advertising material and other content presented to users within a communications network that ameliorates or overcomes one or more disadvantages of known content optimisation methods.

One aspect of the present invention provides a method of optimising content presented to a user within a communications network, wherein the user establishes a session with the communications network, and generates one or more session events during that session, the method including the step of:
at least once during that session comparing the past performance as a traffic stream of multiple sources of content that could be presented to a user to predetermine traffic performance criteria, to enable content to be presented to the user from a content source meeting the predetermined traffic performance criteria.

In one embodiment, the past performance as a traffic stream source of each content source is determined by deriving a traffic performance index for each content source. Content is then presented to a user from the content source having an optimal traffic performance index value.

The traffic performance index maybe derived from one or more key performance indicators representative of user behaviour with each of the multiple sources of content. The key performance indicators maybe derived from predetermined session metrics related to historical session events.

The optimisation may take place before the user requests access to content from one of the multiple sources of content. For example, optimisation may be applied to multiple sources of advertising content, and advertising content having an optimal traffic performance index value displayed to the user.

The optimisation may alternatively take place during a user request for access for content from one of multiple sources of content. For example, a user may request access to content from a predetermined content category, an optimisation applied to multiple sources of content meeting that predetermined content category. Content from a content source within that category having an optimal traffic performance index value may then be displayed to the user.

The optimisation may alternatively take place after the user requests access to content from one of the multiple sources of content. For example, once a user has requested access to content from one of the multiple sources of content, in addition to the requested content, optimised advertising content may also be provided to the user.

The past performance as a traffic stream source of the multiple sources of content may be determined by:
(a) one or more users each establishing a session with related content source within the communications network,
(b) each user generating one or more session events during that session,
(c) determining a session event key for selected session events,
(d) deriving one or more predetermined session metrics related to session events generated during each session,
(e) recording the session metrics against one or more of the session event keys,
(f) processing the recorded session metrics to derive one or more key performance indicators representative of user behaviour in relation to each content source, and
(g) deriving a traffic performance index for each content source from the key performance indicators for that content source.

The session events may include:
(a) an impression event whenever content is accessed by a user from one of the content sources,
(b) a results event whenever a quantifiable result is achieved, and/or
(c) an advertising event whenever advertising content is presented to a user.

A session event key may be determined for at least each impression event.

The recorded session metrics may characterise the number of events generated in sessions in which each impression event occurred. The recorded session metrics may further characterise the number of sessions during which each impression event occurred.

One or more session event keys may be determined for identifying the time at which the session event occurred, such as the current hour, day or other time period or instant.

The session metrics may further characterise the total number of impression events, long held sessions and/or session length.

A session event key may also be determined for each results event.

The session metrics may further characterise the nature, cost and/or revenue of each results event. The session metrics may further characterise the total number of transactions.

A session event key may also be generated for each advertising event. The session event key may characterise the identity of the advertising source.

The session metrics may further characterise the number of banner impressions, clicks and/or unique clicks from banner impressions.

The key performance indicators may be derived by selecting and sorting the session metrics according to one or more session event keys. The key performance indicators may include a click through ratio, click to conversion ratio, session to conversion rate, average number of sites per session, or like indicator characterising the relationship between impression events, results events and/or advertising events.

Data capture may be initiated by a client associated with each user or by a server hosting content accessed by or presented to each user.

The method may further include the step of:
capturing raw user activity data in a log file, and
transmitting the log file to a central server within the communications network.

The log file may be batched or transmitted in real time to the central server.

The method may further include the step:
storing the recorded session metrics in a data storage device associated with the central server.

The data storage device may include one or more data tables of session event keys and corresponding predetermined session metrics.

Another aspect of the present invention provides a central measurement server including a processing unit and associated memory device for storing program code to cause the central measurement server to carry out a method as described above.

A further aspect of the present invention provides a computer program including program code for use with a central measurement server, the central server including a processing unit and associated memory device for storing the program code, wherein the program code causes the central measurement server to carry out a method as described above.

The following description refers in more detail to the various features of the present invention. To facilitate an understanding of the invention, reference is made in the description to the accompanying drawings where the content optimising method and system is illustrated in a preferred embodiment. It is to be understood that the invention is not limited to this preferred embodiment.

In the drawings:

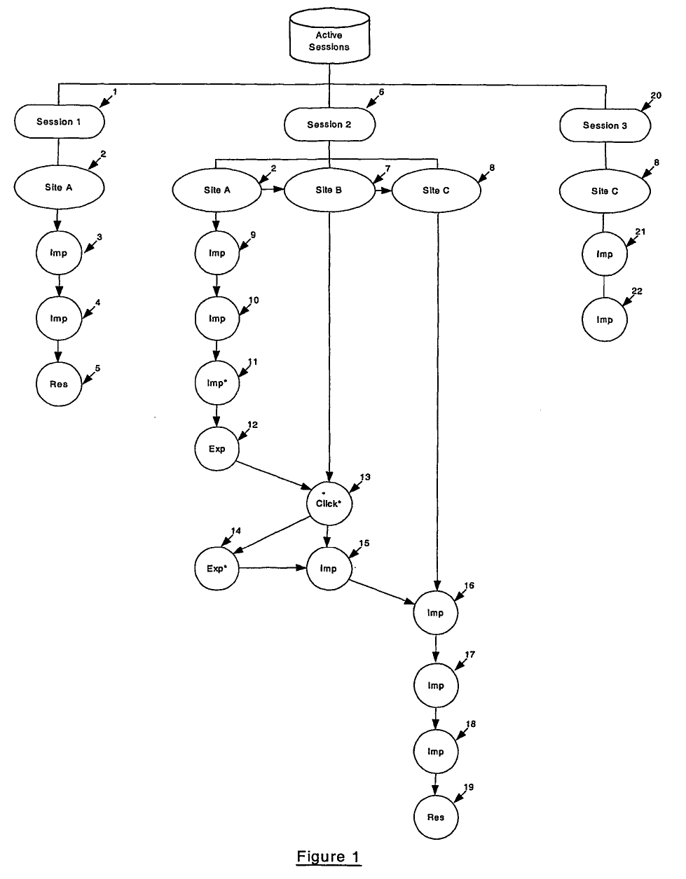

FIG. 1 is a schematic diagram illustrating exemplary content accessed by or presented to users during three sessions established with a communications network;

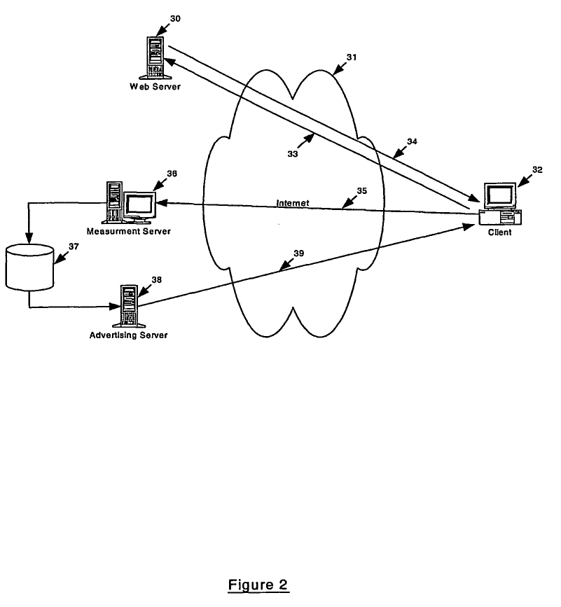

FIG. 2 is a schematic diagram illustrating a communications network including a web server hosting at least part of the content shown in FIG. 1;

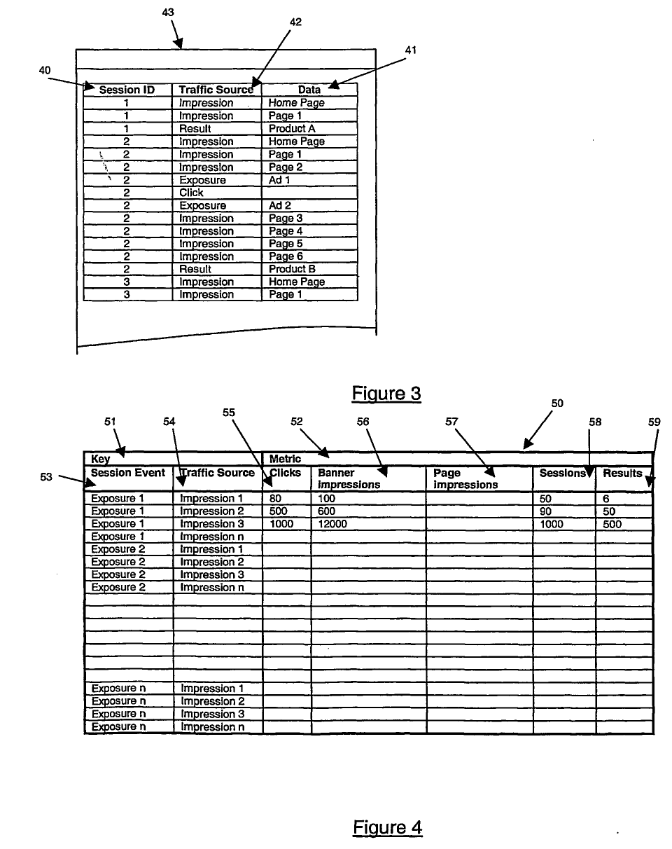

FIG. 3 is an example of a log file recording session event information relating to the interaction of users with the content shown in FIG. 1;

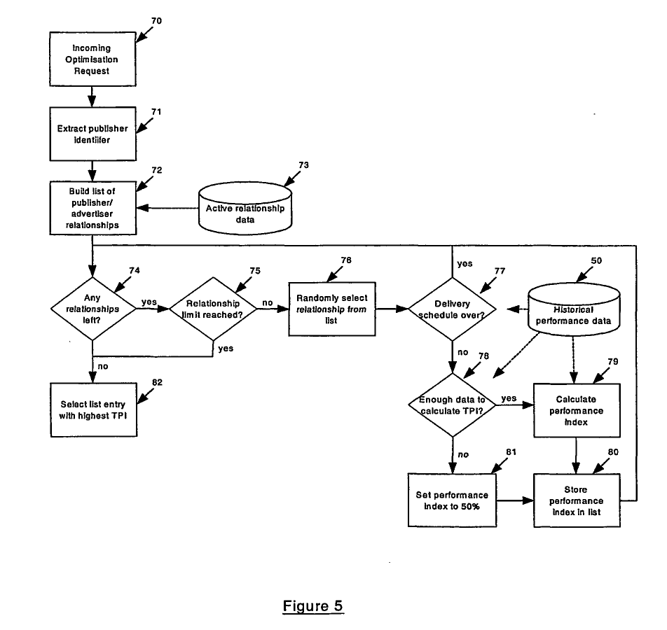

FIG. 4 is an example of a data table recording session event keys and corresponding session metrics derived from the log file shown in FIG. 3; and

FIG. 5 is a flow diagram illustrating one embodiment of a method of optimising the presentation to a user of at least part of the content shown in FIG. 1.

Referring now to FIG. 1, there is shown generally a series of session events resulting from the presentation to or accessing by a user of content from websites during three exemplary connection sessions. The websites and servers hosting the websites form part of the Internet or other communications network. Accordingly, a first user establishes a session 1 with the Internet and requests access to a website 2 by typing the corresponding URL into the address field of a browser installed at a client associated with a user. As the user navigates through the website 2, impression events 3 and 4 are generated whenever a separate HTML document or other source or content is accessed by the user. Many HTML documents presented to the user include HypterText Links to enable a user currently accessing that document to request access to another document or content source within the website 2 or other website.

This and other websites accessed by users may be formed by different content sources providing text, audio, video or other content to a user. In this example, the impression events 3 and 4 may result from the accessing by a user of a product information page, and then a product payment page enabling entry of credit card or alternative payment details for forwarding to a payment authorisation agent. The impression events 3 and 4 then generate a results event 5 when the user achieves a quantifiable result, in this case being provided with access to a payment approval page enabling the user to download a purchased program or other product.

Similarly, the same or a separate user may establish another session 6 with the Internet, during with which content from the website and additional websites 7 and 8 is accessed by or presented to that user. As the user navigates through the website 2, a series of impression events 9 to 11 are generated when the user accesses various HTML documents. The content presented to the user as impression event 11 includes an advertising space in which advertising material is presented to the user. The presentation of advertising material results in the generation of an exposure event 12.

The advertising content presented to the user at exposure event 12 may include a HyperText Link directing the attention of the user to content hosted on the website 7. In this instance, the user clicks on the HyperText Link, thereby generating a click event 13, and effectively requesting access to an HTML document or other content from that site a impression event 15. The HTML document presented to the user may also include an advertising space, which may be filled by advertising material at an exposure event 14.

The user may then navigate from the site 7 to the site 8, and request access to content from that site at impression event 16. Impression events 17 and 18 are generated when separate HTML documents are accessed by the user. Finally, a results event 19 is achieved when the user achieves a measurable goal, such as the purchase of a product, or when the user joins a mailing list.

The same or another user may then establish a further session 20 with the Internet in which HTML documents are accessed from the website 8, resulting in impression events 21 and 22.

In general, impression events document the path taken by a user through the various documents or other content hosted by websites accessible from the Internet from the user's entrance point to the user's exit point during a connection session. Every time access is requested to an HTML document or other content source by a user, and impression event is generated.

Results events document the achievement of a measurable goal, financial, or otherwise, by a user. For example, a results event may be generated when a user joins a mailing list or creates an account with the website, when a user subscribes to a pay-for-access site, when a user purchases digital goods deliverable by the Internet, when a user purchases hard goods deliverable offline, etc. It is to be understood that in addition to financial goals, results events may include the achievement of any event of value to a content provider, such as a user leaving a website or other goal or event.

Exposure events are generated whenever a user is presented with advertising content. The advertising content may enable the user's attention to be directed to a content sources associated with the advertising comment, for example, by clicking on a banner advertisement or text link.

Each of the websites 1, 6 and 20 may be hosted by a merchant web server, such as the exemplary web server 30 shown in FIG. 2, which is accessible from the Internet 31. It will be appreciated that in other embodiments of the invention, the sources of content accessed by or presented to users may be accessible from a communications network other than the Internet, such as a mobile telecommunications network or satellite network.

Initially, a client 32 associated with a user establishes a connection with the Internet 31 and is presented with an HTML page via an Internet service provider. As the user navigates amongst the various HTML documents accessible from a variety of web servers forming part of the Internet 31, the client 32 periodically transmits a request 33 to the web server 30 for access to content from a desired website. Upon receipt of the request, the merchant web server 30 dynamically includes a unique session ID in the content 34 presented to the client 32.

When the content 34 is delivered to the client 32, the client transmits a report 35 to a central measurement server 36. The report 35 includes a token enabling identification of the document or other content provided to the client 32. The token may be realised, for example, by a full URL or file name of the HTML document in question, an HTML page or document title, a customer ID or user name, or other human or machine readable identifier. In addition, the client includes the unique session ID, supplied by the merchant web server 30, in the report 35.

The central measurement server 36 then generates a new session ID record for that user during the current session established with the Internet 31. The client 32 includes the unique session ID and subsequent requests made to the merchant web server 30 or other web server for access to content hosted therein, so that the same session ID may be returned to the client 32, for example, in the URL of the return content. In this way, the reporting of the token to the central measurement server 36 enables the unique session ID to be extracted and content accessed by a user during a single session with the Internet 31 to be linked.

The token identifying each HTML page or other content source is one example of a session event key captured by the central measurement server 36 that facilitate the tracking of user browsing behaviour. In addition, one or more predetermined session metrics relating to session events generated or occurring during each user session are derived from raw user activity data reported to the central measurement server 36. The predetermined session metrics are recorded against one or more session event keys in a database 37 associated with the central measurement server 36.

The central measurement server 36 processes the recorded session metrics maintained in the database 37 to derive one or more key performance indicators representative of user behaviour with the websites or other content sources of the Internet 35. A traffic performance index is then generated by the measurement server 36 for each content source from the key performance indicators derived for that content source, in order to provide an indication of the past performance as a traffic stream source of each content source. Advertising or like content is maintained in an advertising server 38 that selectively presents advertising content 39 to the client 32. The content presented to the client 32 is selected by the advertising server 38 based upon an assessment of the traffic performance index of multiple possible sources of content that can be presented to the client 32 at any one time.

This process will be explained in more detail with reference to FIGS. 3 to 5. As content is accessed or presented to the client 32, and corresponding session events (shown in FIG. 1) are generated, the client 32 captures the current session ID 40 and session event key 41 for each impression and results event generated during the various user sessions. Each session event key enables identification of the HTML document or other content accessed by a user, whilst the session event key for each results event enables identification of the results event generated.

The current session ID and session event key for each session event shown in FIG. 1 is captured in a log file 43, which is batched or transmitted in real time to the central measurement server 36. The raw user activity captured in the log file 43 is then grouped by the central measurement server 36 according to a unique session ID.

As seen in FIG. 4, data from each session is then analysed in order to derive one or more predetermined session metrics relating to session event generated during that session. Summary data is generated from that session data by recording the one or more predetermined session metrics against each session event key. That summary data is then stored in one or more data tables maintained in the database 37.

An example of such a data table is shown in FIG. 4. In this example, the data table 50 includes one or more session event keys 51 and one or more predetermined session metrics 52 corresponding to those session event keys.

A first session event key 53 identifies exposure events occurring in monitored sessions. In addition, a session event key identifying the traffic source resulting in each exposure event is also captured by the central measurement server 36 and added to the data table 50.

As each session event is generated, predetermined session metrics 55 to 59 are derived respectively summarising the number of click events (a user having been directed to a website by clicking on and advertising source), the number of banner impressions recorded for each advertising source, the number of page impressions recorded, the number of sessions in which each exposure event occurred, and the number of results generated from sessions in which each exposure event was generated. It will be appreciated in other examples that various other session event keys may be recorded, and that a variety of other session metrics may be recorded against each session event key.

In particular, a session event key may be determined for each impression event, and session metrics recorded in the data table 50 that characterise the number of results events generated in sessions during which each impression event occurred, or the number of sessions during which each impression event occurred.

In addition, one or more session event keys may be determined to identify the time at which the session event occurred, such as the hour, day or other current time period or instant. The recorded session metrics may further characterise the total number of impression events, long held sessions, session length, etc.

Similarly, session metrics may characterise the nature, cost and/or revenue of each results event, or the total number of transactions. In relation to advertising events, the session metrics recorded may characterise the number of banner impressions, clicks and/or unique clicks from banner impressions, or other relevant data.

The advertising server 38 derives one or more key performance indicators for each exposure event recorded in the data table 50 by selecting and sorting the recorded session metrics according to one or more session event keys. Various examples of key performance indicators that may be derived are as follows:

(a) Click Ratio

A comparison of banner impressions vs. clicks presented as a percentage.

$$[ \frac{Clicks}{Banner Impressions} ] \times 100$$

(b) Average Impressions/Session

A comparison of site impressions vs. held sessions, after an allowance has been made for non-held sessions.

$$[ \frac{seconds - ( sessions - held sessions )}{held sessions} ]$$

(c) Revisitation Rate

Provides a persistent cookie based indicator of how frequently people return to a given site each month.

$$[ \frac{people}{sessions} ]$$

(d) Average Time Spent Visiting (TSV)

A comparison of the total duration spent on line by all users vs. held sessions, after an allowance is made for non-held sessions.

$$\frac{[ \frac{seconds}{held sessions} ]}{60}$$

(e) Adjusted Time Spent Visiting (TSV)

A comparison of the total duration spent online vs. held sessions, after an allowance has been made for non-held sessions.

$$\frac{[ \frac{valuable seconds}{held sessions} ]}{60}$$

(f) Conversion Ratio

A comparison of the total results vs. sessions expressed as a ratio. The ratio is presented as either 1:X or 0:X depending on whether or not any results have been generated (respectively). This may be thought of as a conversion ratio, being “X sessions are required to generate a result”.

It will be appreciated that various other key performance indicators, typically characterising the relation between impression events, results events and/or advertising events, may be envisage by those skilled in the art of web traffic monitoring.

The various key performance indicators derived by the advertising server 38 may have varying degrees of importance to a content provider. The advertising server 38 derives a traffic performance index for each contents source, such as each source of advertising content resulting in a unique exposure event, from one or more of the previously derived key performance indicators for that content source. The traffic performance index (TPI) is derived according to the following expression:
TPIₑₓₚ₁=a.k₁+b.k₂+c.k₃+ . . . +z.kₙ
where a, b, c, . . . z are constants, and k₁, k₂, k3, . . . kn are the various key performance indicators derived for each session event key.

Each traffic performance index provides an indication of the past performance as a traffic stream source or the content associated with each session event key. The traffic performance index of multiple sources of content that could be presented to a user at any time are compared to predetermined traffic performance criteria, and content presented to that user from a content source meeting the predetermined traffic performance criteria As seen in FIG. 5, an incoming optimisation request 70 may be received at central measurement server 36 to provide advertising content for presentation to the client 32. This optimisation request identifies the publisher, or content provider, of the content accessed by or provided to the user when the optimisation request was made. At step 71, the publisher identifier is extracted, and at step 72 a list is built of publishers and suppliers of advertising content with which the publisher has a contractual relationship to publish that advertising content. The list built at step 72 is derived from active relationship data maintained in a data base 73 maintained by the advertising server 38. In the context of the data table 50, shown in FIG. 4, each publisher is identified as a traffic source, whereas each advertiser is identified by a session event key corresponding to an exposure event.

In order to determine which advertising or other content is to be presented to a user, each publisher/advertiser relationship in the list is examined in order to assess the traffic performance indicator of that advertising content. This examination continues until, at step 74, it is determined that no relationships remain, or, at step 75, that a predetermined number of relationships have already been examined (in order to limit processing requirements).

If relationships remain to be examined, and a publisher/advertiser relationship limit has not been reached, a publisher/advertiser relationship is randomly selected from the previously constructed list at step 76. If it is determined at step 77 that a predetermined delivery schedule for that advertising content has not concluded, it is determined at step 78 whether enough data has been collected in the data table 50 to enable the calculation of a traffic performance index for that advertising content.

If this is the case, then the traffic performance for that index for that advertising source is calculated at step 79, in accordance with the manner previously described. That traffic performance index is then stored, at step 80, in the database 37 for later access by the advertising server 38. Alternatively, if not enough historical performance data has been accumulated in the data table 50 to enable calculation of the traffic performance index, the traffic performance index for that advertising content is set to an arbitrary value of 50% at step 81.

Once all publisher/advertiser relationship have been examined, or the predetermined number of publisher/advertiser relationships reached, the advertising content having the highest traffic performance index is then selected at step 82 for presentation to the client 32.

The optimisation of advertising or other content present to the client 32 can be applied before, during or after network user attemption has been caught during a particular connection section. For example, during the session 6 shown in FIG. 1, the central measurement server 36 may detect that the impression event 11 has occurred, and request that the advertising server 38 provide advertising content to the client 32. In this case, the traffic performance index of multiple sources of advertising content may be examined, and advertising content having the highest traffic performance index value displayed to the user.

In another example, the central measurement server 36 may detect that the click event 13 has occurred, by which a user has requested access to content from a predetermined content category, without knowing the identity of the content provider. In this case, the traffic performance index of multiple sources of content meeting that predetermined content category may be optimised in order to determine the source of content having the highest traffic performance index value. That optimised content may then be provided and result in the impression event 15. By way of a further example, the click event 13 may have resulted in the user requesting direct access to content from a known content provider, resulting in the generation of impression event 15. However, an intermediary funnel page may instead be presented to the user containing a variety of advertising messages, including the advertising content resulting in the generation of the exposure event 14. Once again, the traffic performance index of content from multiple possible sources of content that can be displayed to the user is examined, and optimised advertising content then provided to the client 32.

From the foregoing, it will be appreciated that the present invention addresses the privacy concerns of current targeted content providing schemes, because profiling is based on the aggregated performance of a traffic stream, rather than one or more individuals habits. Moreover, an online media buyer can reliably predict the performance of a specific traffic stream based upon historically recorded data and derived key performance indicators and the resulting traffic performance index for each content source.

A further advantage of the present invention is the reduced storage and processing requirements of aggregated profiling, compared to that required for individual profiling. Even as traffic flow increases, the storage and processing requirements remain static.

Finally, it is to be understood that various modifications and/or additions may be made to the method of optimising content presented to a user without departing from the spirit or ambit of the invention as described hereabove.

1. A method of optimising content presented to a user within a communications network, wherein the user establishes a session with the communications network and generates one or more session events during that session, the method including the step of:
at least once during that session comparing past performance as a traffic stream of multiple sources of content that could be presented to a user to predetermine traffic performance criteria, to enable content to be presented to the user from a content source meeting the predetermined traffic performance criteria.

2. The method according to claim 1, wherein the past performance as a traffic stream source of each content source is determined by deriving a traffic performance index for each content source.

3. The method according to claim 2, wherein content is presented to a user from the content source having an optimal traffic performance index value.

4. The method according to claim 3, wherein the traffic performance index is derived from one or more key performance indicators representative of user behaviour with each of the multiple sources of content.

5. The method according to claim 4, wherein the key performance indicators are derived from predetermined session metrics related to historical session events.

6. The method according to claim 1, wherein optimisation takes place before the user requests access to content from one of the multiple sources of content.

7. The method according to claim 1, wherein the optimisation takes place during a user request for access for content from one of multiple sources of content.

8. The method according to claim 7, wherein a user requests access to content from a predetermined content category, and optimisation is applied to multiple sources of content meeting that predetermined content category.

9. The method according to claim 8, wherein content from a content source within the predetermined content category having an optimal traffic performance index value is displayed to the user.

10. The method according to claim 1, wherein optimisation takes place after the user requests access to content from one of the multiple sources of content.

11. The method according to claim 10, wherein a user requests access to content from one of the multiple sources of content, and in addition to the requested content, optimised advertising content is then provided to the user.

12. The method according to claim 1, wherein the past performance as a traffic stream source of the multiple sources of content is determined by:
(a) one or more users each establishing a session with related content source within the communications network,
(b) each user generating one or more session events during that session,
(c) determining a session event key for selected session events, (d) deriving one or more predetermined session metrics related to session events generated during each session,
(e) recording the session metrics against one or more of the session event keys,
(f) processing the recorded session metrics to derive one or more key performance indicators representative of user behaviour in relation to each content source, and
(g) deriving a traffic performance index for each content source from the key performance indicators for that content source.

13. The method according to claim 12, wherein the session events include at least one of:
(a) an impression event whenever content is accessed by a user from one of the content sources,
(b) a results event whenever a quantifiable result is achieved, and,
(c) an advertising event whenever advertising content is presented to a user.

14. The method according to claim 13, wherein a session event key is determined for at least each impression event.

15. The method according to claim 12, wherein the recorded session metrics characterise the number of events generated in sessions in which each impression event occurred.

16. The method according to claim 15, wherein the recorded session metrics further characterise the number of sessions during which each impression event occurred.

17. The method according to claim 12, wherein one or more session event keys are determined for identifying the time at which the session event occurred.

18. The method according to claim 12, wherein the session metrics further characterise the total number of at least one of impression events, long held sessions and session length.

19. The method according to claim 12, wherein a session event key is determined for each results event.

20. The method according to claim 12, wherein the session metrics further characterise the nature, cost and/or revenue of each results event.

21. The method according to claim 20, wherein the session metrics further characterise the total number of transactions.

22. The method according to claim 12, wherein a session event key is generated for each advertising event.

23. The method according to claim 22, wherein the session event key characterises the identity of the advertising source.

24. The method according to claim 12, wherein the session metrics characterise the number of banner impressions, clicks and/or unique clicks from banner impressions.

25. The method according to claim 12, wherein the key performance indicators are derived by selecting and sorting the session metrics according to one or more session event keys.

26. The method according to claim 25, wherein the key performance indicators include at least one of a click through ratio, click to conversion ratio, session to conversion rate, average number of sites per session or like indicator characterising the relationship between impression events, results events and advertising events.

27. The method according to claim 1, wherein data capture is initiated by a client associated with each user or by a server hosting content accessed by or presented to each user.

28. The method according to claim 27, the method further including the steps of:
capturing raw user activity data in a log file, and
transmitting the log file to a central server within the communications network.

29. The method according to claim 28, wherein the log file is batched or transmitted in real time to the central server.

30. The method according to claim 29, the method further including the step:
storing the recorded session metrics in a data storage device associated with the central server.

31. The method according to claim 30, wherein the data storage device includes one or more data tables of session event keys and corresponding predetermined session metrics.

32. A central measurement server including a processing unit and associated memory device for storing program instructions to cause the central measurement server to carry out a method according to claim 1.

33. A computer program including program instructions for use with a central measurement server, the central server including a processing unit and associated memory device for storing the program instructions, wherein the program instructions causes the central measurement server to carry out a method according to claim 1.
